(19) United States
(12) Patent Application Publication
(10) Pub. No.: US 2004/0052951 A1
(43) Pub. Date: Mar. 18, 2004

(54) Rubber composition comprising plastisol formed flow properties

(76) Inventors: Ralf Sauer, St. Leon-Rot (DE); Thomas Zahn, Heidelberg (DE); Peter Born, Sandhausen (DE); Angelika Butt, Griesheim (DE)

Correspondence Address: Connolly Bove, Lodge & Hutz, PO Box 2207, Wilmington, DE, 19899-2207, US

(21) Appl. No.: 10/450,547

(22) PCT Filed: Dec. 7, 2001
(86) PCT No.: PCT/EP01/14384

(30) Foreign Application Priority Data
Dec. 16, 2000 (DE) 10062860.5

(51) Int. Cl. B05D 3/02

(52) U.S. Cl. 427/385.5

(57) ABSTRACT

Hot-curing reactive compositions based on natural and/or synthetic elastomers which contain olefinic double bonds and vulcanization agents which contain, apart from conventional liquid polyenes, at least one liquid cis-1,4-polyisophere with a molecular weight between 20 000 and 70 000 and a vulcanization system consisting of sulfur, accelerators and quinonoximes, exhibit plastisol-like flow characteristics so that they can be applied at room temperature using conventional spray units. These compositions are suitable as joint-sealing and sealing compositions, as underseal adhesives and as structural adhesives such as e.g. lap-joint adhesives.

The invention relates to single-component hot-curing compositions.based on liquid rubbers, which have plastisol-type flow characteristics, their use in car shells and a process for sealing, bonding or undersealing structural parts in vehicle shells.

The bonding or sealing of metal sheet parts in vehicle shells, in particular for car bodies, is frequently performed with crude metal sheet parts. Curing of the adhesive/sealant used takes place later in the lacquer drying kiln. The bonded or sealed parts first pass through cleansing, phosphatizing and dip-priming stages. The treatment agents used in these stages can cause the adhesive or sealant to be washed out of the bonded joints. In order to meet these requirements, various procedures have been disclosed, e.g. thermal/inductive precuring of low-viscosity, pasty adhesive/sealants, the use of adhesives in the form of solvent-containing compositions or hot-melts, as two-component products or as molded items, which are generally applied manually and have an intrinsic tackiness at the time of application. These molded items may be present in the form of strips or O-rings or as stamped parts or as sections with any cross-section at all.

Low-viscosity, pasty adhesives/sealants can be inserted especially simply by injection or spray application or by spot application or also by extrusion, therefore these types of products, in particular those based on plastisols, are also often used when constructing shells.

Plastisols are generally understood to be dispersions of organic plastics in plasticisers which gel when heated to an elevated temperature and cure on cooling. Most of the plastisols still currently used in practice mainly contain finely powdered polyvinyl chloride (PVC) which is dispersed in a liquid plasticiser and forms a paste. These types of polyvinyl chloride plastisols are used for very different purposes. They are used, inter alia, as sealing compositions, e.g. for joint sealing in the case of metal containers or as lap-joint adhesives in the metal industry, as anticorrosive coatings for metals (for example as underfloor protection in motor vehicles), for impregnating and coating substrates made of textile materials (e.g. as carpet backings) as cable insulation etc. Plastisols based on finely powdered methacrylate copolymers (PMMA) or styrene copolymers have also been disclosed. These types of plastisols, in particular those based on PVC or PMMA, are also widely used in the construction of car shells; to underseal reinforcing structures such as engine bonnets, trunk lids, doors and roof structures and also for lap-joint bonding and for the sealing of joints made using other joining processes. Favorable flow characteristics are an advantage when using plastisols for these purposes, in particular at room temperature. In order to ensure washer-resistance during the various cleansing, phosphatizing and dip-priming stages when manufacturing car bodies, these plastisol compositions are often gelled in a pregelling process to the point where their viscosity is high enough to ensure this washer-resistance and to give initial strength to the components.

Apart from the previously mentioned advantages, plastisol compositions have a number of serious disadvantages. Thus, their age-resistance exhibits great weakness so that a drop in quality is produced as a result of corrosion and the associated loss in adhesion. It has been shown in particular that the plastisols used in shells may tend to absorb moisture. In the case of components which have only been pregelled and then either have to be stored for a long time or have to be transported some distance to a production location, the latter is especially serious. Furthermore, they exhibit certain weaknesses in age-resistance when tested in the VDA cycle test and salt spray test in accordance with DIN 50021. The storage stability of these types of plastisol compositions also requires improvement because the disperse phase and the liquid phase tend gradually to separate. Furthermore, they tend to “set”; i.e. when stored for long periods, probably due to agglomeration processes, the material becomes so highly viscous that it first has to be subjected to a high degree of shear before application, in order to convert it back into a low-viscosity, sprayable condition. In addition, plastisol compositions are very sensitive with regard to the maximum storage temperature; they have to be stored below 40° C. in any case because otherwise partial gelling of the plastisol takes place. In addition, cured plastisols also have a thermoplastic character, i.e. their strength is greatly restricted at elevated temperatures, so they cannot be used for structural bonding.

Therefore reinforced compositions based on vulcanisable rubber mixtures have recently been suggested as alternative adhesives or sealants and sealing compositions. EP-B-97394 describes an adhesive mixture based on a liquid polybutadiene rubber, powdered sulfur, organic accelerators and optionally solid rubbers. B. D. Ludbrook, Int. J. Adhesion and Adhesives vol. 4, no. 4, p. 148-150, states that these types of adhesives based on liquid polybutadiene can achieve, by appropriate choice of the amount of sulfur and accelerators, strength values which are equivalent to those of flexibilized epoxy adhesives. Whereas these formulations have good curing properties and good age-resistance, and also exhibit reasonably useful adhesion to normal oiled steel sheeting, their capacity for use with many types of galvanized steel sheeting is unsatisfactory. In addition, the elongation at break of these high-strength rubber adhesives is very low. They cannot be sprayed and have to be extruded at elevated temperature.

To improve the adhesion, DE-C-3834818 suggests using OH-terminated polybutadienes as the liquid rubber. In accordance with EP-B-441244, apart from hydroxy-functional homopolymers or copolymers, those with thiol, amino, amido carboxyl, epoxy, isocyanate, anhydride or acetoxy groups may be used as functional rubber polymers, wherein, however, the cured adhesive mixture has an elongation at break which does not exceed 15%.

In accordance with EP-B-309903 or DE-C-4027064, polyfunctional epoxy compounds may be added to adhesive mixtures based on liquid rubbers in order to improve the adhesion or to improve the tensile shear strength. Apart from the fact that it is undesirable, for occupational health reasons, to use adhesive compositions which contain low molecular weight epoxy resins, the adhesive compositions described in the two last-mentioned documents are not suitable as structural adhesives because they only achieve a very low strength of 3 MPa maximum.

WO 96/23040 describes single-component hot-curing structural adhesives based on liquid rubbers which may optionally contain small proportions of functional groups, solid rubbers, thermoplastic polymer powders and sulfur as well as vulcanization accelerators, these being suitable for bonding metal parts. Tensile shear strengths of more than 15 MPa and at the same time a high elongation at break of more than 15% can be obtained. These adhesives are substantially free of low molecular weight epoxide resins and are suitable in particular for use in the construction of car shells.

WO 99/03946 discloses hot-pumpable, hot-curing compositions based on ethylene/vinyl acetate copolymers (EVA) containing at least one solid EVA copolymer with a softening point higher than 50° C., measured by the ring-and-ball method according to ASTM D 28, at least one liquid reactive plasticiser with olefinically unsaturated double bonds and at least one peroxidic cross-linking agent. According to the data given in this document, these compositions are suitable as sealing agents for fine and coarse joints in the construction of vehicles. These can also be used as underseal adhesives when blowing agents are added. The preferred areas of use are for the manufacture of car shells.

Although the rubber compositions in the previously mentioned prior art are generally very good for use when manufacturing car shells (they also have outstanding properties with regard to washer-resistance and age-resistance and they have the required technical properties), a substantial disadvantage of these rubber compositions is their very high viscosity, so they can generally only be applied by pumping when hot. They cannot be applied using conventional spray processes such as e.g. the airless process. In view of this prior art, the inventors faced the object of providing hot-curing rubber compositions which have the beneficial processing and flow properties of classical plastisol, without having the previously mentioned disadvantages.

This object is achieved, according to the invention, as detailed in the claims and substantially comprises the provision of a hot-curing reactive composition based on natural and/or synthetic liquid elastomers containing olefinic double bonds and vulcanization agents, wherein these compositions contain at least one liquid cis-1,4-polyisoprene with a molecular weight between 20 000 and 70 000 and a vulcanization system consisting of sulfur, accelerator and quinonoximes.

The present invention also provides the use of these hot-curing reactive compositions as single- or two-component adhesives, sealants, sealing compositions or coating compositions in car shells.

The present invention also provides a process for sealing coarse and/or fine joints in vehicle shells or a process for undersealing or bonding structural parts in vehicle shells, which includes the following essential process steps:

a) applying the previously mentioned composition to at least one shell part by spraying or extruding,

b) joining the shell parts, optionally followed by (spot)-welding, lap-jointing, screwing and/or riveting,

c) optionally partly curing the composition by briefly heating the parts to temperatures of up to 190° C.,

d) optionally cleaning/washing the joined shell parts optionally followed by conventional surface pre-treatments,

e) electrodeposition lacquering, curing and/or cross-linking the sealing composition while firing on the electrodeposition lacquer at temperatures between 160° C. and 240° C.

The essential features of the compositions according to the invention are the absence of solid rubbers, i.e. rubbers with a molecular weight of 100 000 or above. Another essential characteristic of compositions according to the invention is the use of liquid cis-1,4-polyisoprenes with a molecular weight between 20 000 and 70 000. These liquid polyisoprenes supply the requisite elasticity and high strength to the cured rubber compositions.

Reactive compositions according to the invention contain at least one of the following substances:

one or more liquid cis-1,4-polyisoprene(s) with a molecular weight between 20 000 and 70 000, preferably between 20 000 and 50 000,

one or more further liquid rubbers or elastomers,

vulcanizing agents, vulcanization accelerators, catalysts,

fillers, pigments,

tackifiers and/or bonding agents,

blowing agents,

extender oils,

anti-ageing agents,

rheology auxiliary substances.

The liquid rubbers or elastomers contain at least one olefinically unsaturated double bond per molecule. They may be chosen from the following group of homopolymers and/or copolymers:

polybutadienes, in particular 1,4- and 1,2-polybutadienes, polybutenes, polyisobutylenes, 1,4- and 3,4-polyisoprenes, styrene/butadiene copolymers, butadiene/acrylonitrile copolymers, wherein one or more of these polymers may have terminal and/or (randomly distributed) lateral functional groups. Examples of these types of functional groups are hydroxy, amino, carboxyl, carboxylic anhydride or epoxy groups. The molecular weight of these liquid rubbers is typically less than 20 000, preferably between 900 and 10 000. The proportion of liquid rubber in the entire composition depends on the required rheology of the uncured composition and the required mechanical rigidity or strength of composite and on the acoustic damping properties of the cured composition. The proportion of liquid rubber or elastomer normally varies between 5 and 50 wt. % of the entire formulation. It has proven expedient preferably to use mixtures of liquid rubbers with different molecular weights and a different configuration with respect to the remaining double bonds. To produce optimum adhesion to various substrates, a proportion of liquid rubber components with hydroxy groups or acid anhydride groups is used in particularly preferred formulations. At least one liquid rubber should contain a high proportion of cis-1,4-double-bonds, another a high proportion of vinyl double bonds.

In contrast to previously known adhesives and sealants and sealing agents based on rubber, compositions according to the invention are characterized by the absence of solid rubber. Solid rubbers, as is well known, have molecular weights greater than 100 000. Another substantial difference in the compositions according to the invention is that they contain one or more liquid cis-1,4-polyisoprenes with a molecular weight between 20 000 and 70 000, preferably between 20 000 and 50 000.

Compositions according to the invention may optionally also contain finely distributed thermoplastic polymer powders. Examples of suitable thermoplastic polymers are polypropylene, polyethylene, thermoplastic polyurethanes, methacrylate copolymers, styrene copolymers, polyvinyl chloride, polyvinyl acetate and in particular polyvinyl acetate and copolymers thereof such as, for example, ethylene/vinyl acetate copolymers. Although the particle size and particle size distribution of the polymer powder does not appear to be particularly critical, the average particle size should be less than 1 mm, preferably less than 350 μm. The amount of optionally added thermoplastic polymer powder is between 0 and 20 wt. %, preferably between 2 and 10 wt. %.

The cross-linking or curing reaction of the rubber composition and the expansion process have a decisive effect on the sealing function, on acoustic damping and on the reinforcing effect or strength of the structural part. Therefore, the vulcanization system and optionally the blowing agent composition must be chosen and combined particularly carefully. A number of vulcanization agents combined with elemental sulfur, but also vulcanization systems without free sulfur, is suitable as the vulcanization system. The latter include vulcanization systems based on thiuram disulfides, organic peroxides, polyfunctional amines, quinones, p-benzoquinone dioxime, p-nitrosobenzene and dinitrosobenzene or else cross-linking with (blocked) diisocyanates. However, vulcanization systems based on elemental sulfur and organic vulcanization accelerators and also zinc compounds are very particularly preferred. Powdered sulfur is used in amounts of 4 to 15 wt. %, with respect to the entire composition, amounts between 6 and 8% being particularly preferably used. Suitable organic accelerators are dithiocarbamates (in the form of their ammonium or metal salts), xanthogenates, thiuram compounds (monosulfides and disulfides), thiazole compounds, aldehyde/amine accelerators (e.g. hexamethylene tetramine) and guanidine accelerators; dibenzothiazole disulfide (MBTS), 2-mercaptobenzthiazole (MBT), its zinc salt (ZMBT) or diphenylguanidine are very particularly preferred. According to the invention, particularly advantageous vulcanization properties and ultimate properties of the cured rubber compositions are produced when a combined vulcanization system consisting of elemental sulfur, the organic accelerators mentioned above and quinone dioximes are used. Para-benzoquinone dioxime may be mentioned by way of example, but other quinone dioximes may also be used in combination with the previously mentioned sulfur systems. These organic accelerators are used in amounts between 2 and 10 wt. %, with respect to the entire formulation, preferably between 3 and 8 wt. %. The zinc compounds acting as accelerators may be chosen from among the zinc salts of fatty acids, zinc dithiocarbamates, basic zinc carbonates and in particular finely divided zinc oxide. The concentration of zinc compounds is in the range between 1 and 10 wt. %, preferably between 3 and 7 wt. %. In addition, other typical rubber vulcanization auxiliary substances such as fatty acids (e.g. stearic acid) may be present in the formulation.

To produce expansion during the curing process, in principle any commonly used blowing agents may be used, preferably, however, organic blowing agents from the classes of azo compounds, N-nitroso compounds, sulfonyl hydrazides or sulfonyl semicarbazides are used. Azo compounds which may be mentioned for use according to the invention are, for example, azobisisobutyronitrile and in particular azodicarbonamide, examples from the class of nitroso compounds are dinitrosopentamethylene tetramine, from the class of sulfohydrazides 4,4′-oxybis(benzenesulfonic acid hydrazide), diphenylsulfone-3,3′-disulfohydrazide or benzene-1,3-disulfohydrazide and from the class of semicarbazides p-toluenesulfonyl semicarbazide.

Instead of the previously mentioned blowing agents, so-called expandable microspheres may also be used, i.e. non-expanded thermoplastic polymer powders, these being soaked with or filled with low-boiling organic liquids. These types of microspheres are described, for example, in EP-A-559254, EP-A-586541 or EP-A-594598. Although not preferred, pre-expanded microspheres may also be used or co-used. Optionally, these expandable/expanded microspheres may be combined in any ratio by weight with the “chemical” blowing agents mentioned above. The chemical blowing agents are used in expandable compositions in amounts between 0.1 and 3 wt. %, preferably between 0.2 and 2 wt. %, the microspheres are used in amounts between 0.1 and 4 wt. %, preferably between 0.2 and 2 wt. %.

Although compositions according to the invention generally already have very good adhesion to substrates, due to the preferred concentration of liquid rubber with functional groups, tackifiers and/or bonding agents may be added, if required. Suitable for this purpose are, for example, hydrocarbon resins, phenol resins, terpene/phenol resins, resorcinol resins or their derivatives, modified or unmodified resin acids or esters (abietic acid derivatives), polyamines, polyaminoamides, anhydrides and anhydride-containing copolymers. The addition of polyepoxy resins in small amounts may also improve adhesion to some substrates. However solid epoxide resins with a molecular weight of more than 700, in a finely milled form, are then preferably used for this purpose. If tackifiers or bonding agents are used, the type and amount used depends on the polymer composition and on the substrate to which the composition is to be applied. Typical tackifying resins such as e.g. terpene/phenol resins or resin acid derivatives are used in concentrations between 5 and 20 wt. %, typical bonding agents such as polyamines, polyaminoamides or phenol resins or resorcinol derivatives are used in the range between 0.1 and 10 wt. %.

Compositions according to the invention preferably contain no plasticisers and extender oils. It may be necessary, however, to influence the rheology of the uncured composition and/or the mechanical properties of the cured composition by adding so-called extender oils, i.e. aliphatic, aromatic or naphthenic oils. Nevertheless, this preferably takes place by the expedient choice of low molecular weight liquid rubbers or by the co-use of low molecular weight polybutenes or polyisobutylenes. If extender oils are used, amounts in the range between 2 and 15 wt. % are used.

Fillers may be chosen from a number of materials, the following in particular are mentioned here: chalks, natural or milled calcium carbonates, calcium magnesium carbonates, silicates, talcum, barytes and carbon black. Optionally, it may be expedient that at least some of the filler is surface-pretreated, in particular it has proven expedient to provide the various calcium carbonates or chalks with a coating of stearic acid to prevent the introduction of moisture and to reduce the moisture sensitivity of the cured composition. Optionally, compositions according to the invention also contain between 1 and 20 wt. %, preferably between 2 and 15 wt. % of calcium oxide. The total amount of fillers in the formulation may vary between 10 and 70 wt. %, the preferred range being between 25 and 60 wt. %.

Conventional stabilizers or antioxidants against thermal, thermal-oxidative or ozone degradation of compositions according to the invention, such as e.g. sterically hindered phenols or amine derivatives may be used, typical amounts for these stabilizers being in the range 0.1 to 5 wt. %.

Although the rheology of compositions according to the invention can be brought into the desired range by the choice of fillers and the ratio by weight of the low molecular weight liquid rubbers, conventional rheology auxiliary substances such as e.g. pyrogenic silica, bentonites or fibrillated or pulp short fibers in the range between 0.1 and 7%, or also hydrogenated castor oil derivatives, known e.g. under the trade name Rilanit (Cognis), may be added. In addition, other conventional auxiliary substances and additives may be used in compositions according to the invention.

Compositions according to the invention, as compared with the prior art, have flow properties which are very similar to those of plastisols, without having the previously mentioned disadvantageous properties, i.e. the age-resistance is improved as compared with conventional plastisols, the water absorption of applied and uncured materials is greatly reduced. This means that they have the good processing properties associated with the rheology of conventional plastisols, but at the same time they have the very good age-resistances and strength values of conventional vulcanisable (curable) rubber compositions. For this reason, they may also be referred to as “rubber plastisols”, although their compositions do not correspond to those of typical plastisols. Apart from the preferred embodiment as a single-component hot-curing adhesive/sealant or sealing composition, compositions according to the invention may also be built up as two-component systems, analogous to the two-component adhesives described in EP 356715. This embodiment is also an explicit object of the present invention.

The main field of application for hot-curing reactive compositions according to the invention is so-called shells in the car industry. Here, the parts which later form the hollow spaces in the bodywork or which later form joint seams are readily accessible so that application can be performed with traditional pumping, metering, spraying or extruding devices for low viscosity, pasty materials. Preferred fields of application for compositions according to the invention are underseal adhesives for car bonnets and trunk lids or also door structures or roof structures and side part structures as well as lap-joint adhesives or lap-joint sealing materials.

The process temperatures in the various lacquer kilns are available for the curing and optional expansion reactions of the compositions, i.e a temperature range between 80° C. and 240° C. for about 10 to 35 minutes. Passage of the bodywork or parts through a so-called “EC kiln” is preferably used to cure and optionally expand the compositions according to the invention, i.e. temperatures between 160° C. and 200° C.

During the course of manufacture it may be sensible for pregelling or partial curing to take place after application of the composition according to the invention and joining of the structural parts. For this purpose, any pregelling devices known per se, such as e.g. pregelling kilns or else induction heating units, may be used. A typical temperature range for pregelling is between 100° C. and 160° C. In particular in the case of induction heating, only a very short heating period, in the region of a few seconds, is required, wherein the substrate temperature may be up to 190° C. and may be much higher than that for a short time.

The compositions according to the invention may be prepared in a manner known per se in mixing equipment with a high shear action, including, for example, compounders, planetary mixers, intimate mixers, so called Banbury mixers and similar mixing equipment known to a person skilled in the art.

The invention is explained in more detail in the following working examples, wherein the choice of examples is not intended to be a restriction on the scope of the object according to the invention.

### EXAMPLES

In the following, “rubber plastisols” according to the invention are compared with traditional compositions based on hot-applicable rubber materials with a proportion of solid rubber and with plastisols from the prior art.

### Example 1 (Comparison)

Standard Formulation, Reactive Underseal Adhesive Based on Rubber with a Proportion of Solid Rubber

| | |
|---|---|
| 4.70 | cis-1,4-polybutadiene, solid |
| 4.00 | zinc oxide |
| 2.50 | calcium oxide |
| 0.50 | 2,2-methylene-bis-(4-methyl-6-tert.-butylphenol) |
| 0.50 | carbon black |
| 0.10 | microspheres |
| 21.45 | calcium carbonate |
| 19.60 | calcium carbonate, coated with stearate |
| 25.245 | polybutadiene, liquid, MW ca. 1800, |
| | cis-1,4 ca. 72% |
| 6.85 | polybutadiene with active carboxyl groups, |
| | MW 1700 |
| 4.00 | technical-grade white oil |
| 6.00 | sulfur |
| 4.00 | MBTS |
| 0.05 | azodicarboxylic diamide |
| 0.005 | benzenesulfonic acid, zinc salt |
| 0.50 | silicon dioxide |

### Example 2 (Comparison)

Underseal Adhesive Based on PMMA Plastisol

| | |
|---|---|
| 18.00 | polymethylmethacrylate |
| 30.30 | alkylsulfonic ester of phenol |
| 3.50 | 2-ethyl-hexyl-benzyl phthalate/benzyloctyl |
| | phthalate |
| 0.30 | imidazole |
| 3.00 | araliphatic polyetheramine |
| 2.00 | siliceous chalk (natural agglomerate, consisting |
| | of quartz and lamellar kaolinite) |
| 27.00 | barium sulfate |
| 4.90 | CaO |
| 9.00 | graphite |
| 1.20 | conductive carbon black |
| 0.30 | benzenetetracarboxylic-1,2,4,5-dianhydride |
| 0.30 | methyl-hexahydrophthalic anhydride |
| 0.20 | fatty alcohol ester |

### Example 3 (According to the Invention)

Underseal Adhesive Based on a “Rubber Plastisol”

| | |
|---|---|
| 7.00 | cis-1,4-polyisoprene, liquid, MW 29000 |
| 8.00 | zinc oxide |
| 8.00 | calcium oxide |
| 0.50 | 2,2-methylene-bis-(4-methyl-6-tert.-butylphenol) |
| 3.00 | carbon black |
| 0.50 | ca. 65% p-benzoquinone dioxime, desensitized with |
| | ca. 35% mineral oil raffinate |
| 17.10 | Mg-Al silicate |
| 9.40 | calcium carbonate, coated with stearate |
| 13.00 | polybutadiene, liquid, MW ca. 1800, |
| | cis-1,4 ca. 72% |
| 2.70 | polybutadiene with active carboxyl groups, |
| | MW ca. 1700 |
| 9.50 | low molecular weight, stereospec. polybutadiene |
| | oil, MW 1800, vinyl 50% |
| 5.50 | sulfur |
| 4.50 | MBTS |
| 0.50 | MBT |
| 0.50 | ZMBT |
| 9.00 | technical grade white oil, paraffin raffinate |
| 0.30 | zinc dimethyldithiocarbamate |
| 1.00 | silicon dioxide (amorphous) |

Rheological Data:

Method: Bingham shear rate test: principle plate-plate rotational viscometer, spindle MP 53, temperature 20° C., gap width 0.2 mm, Profile: 60 s preheating, 120 s 0-200 rpm, 120 s const. 200 rpm, 120 s 200-0 rpm. Then the 20th experimental point (a) and the 41st experimental point (b) were read off (special BMW method with experimental measuring points).

| | Ex. 1 | Ex. 2 | Ex. 3 |
|---|---|---|---|
| Viscosity: [Pa.s] | a: 96.12 | a: 44.12 | a: 52.6 |
| | b: 51.41 | b: 35.70 | b: 47.7 |
| TSS (25 × 20 × 3 mm) | | | |
| Temp: 25′ 175° C. | 1.95 MPa | 2.80 MPa | 2.18 MPa |

From the rheological data measured, it is clear that the underseal adhesive in accordance with example 1 has such unfavorable flow properties at room temperature that it is unsuitable for application at room temperature with traditional plastisol application units, such as e.g. airless spray devices. Whereas the adhesive according to the invention in example 3 has similar flow properties to those of the conventional plastisol in example 2. At the same time, it is clear that the tensile shear strength (TSS) of the example according to the invention is also within the range of the strength specifications for underseal adhesives.

### Examples 4 -5

Effect of cis-1,4-polyisoprene (MW 29000) as compared with polybutadiene (MW 1800)

| Ex. 4 | Ex. 5 | |
|---|---|---|
| 7.00 | 4.00 | cis-1,4-polyisoprene, liquid, MW 29000 |
| 8.00 | 8.00 | zinc oxide |
| 8.00 | 8.00 | calcium oxide |
| 0.50 | 0.50 | 2,2-methylene-bis-(4-methyl-6- |
| | | t-butylphenol) |
| 0.50 | 0.50 | ca. 65% p-benzoquinone dioxime, |
| | | desensitized with ca. 35% mineral oil |
| | | raffinate |
| 19.30 | 19.30 | Mg-Al silicate |
| 9.40 | 9.40 | calcium carbonate, coated with stearate |
| 12.80 | 15.80 | polybutadiene, liquid, MW ca. 1800, |
| | | cis-1,4 ca. 72% |
| 2.70 | 2.70 | polybutadiene with active carboxyl |
| | | groups, MW ca. 1700 |
| 10.25 | 10.25 | low mol. wt., stereospec. polybutadiene |
| | | oil, MW 1800, vinyl 50% |
| 1.75 | 1.75 | sulfur |
| 4.50 | 4.50 | MBTS |
| 0.50 | 0.50 | MBT |
| 0.50 | 0.50 | ZMBT |
| 9.00 | 9.00 | technical grade white oil, paraffin |
| | | raffinate |
| 0.30 | 0.30 | zinc dimethyldithiocarbamate |
| 3.00 | 3.00 | titanium dioxide |
| 1.50 | 1.50 | hydrogenated castor oil |

Results:

| | Ex. 4 | Ex. 5 |
|---|---|---|
| Viscosity [Pas] | a: 36.7 | a: 34.9 |
| | b: 33.4 | b: 31.8 |
| TSS | | |
| Min. 15′ 160° C. | 0.87 MPa, 100% cf | 0.61 MPa. 100% cf |
| Max. 25′ 175° C. | 0.60 MPa, 100% cf | 0.34 MPa, 75% cf |
| Elong. at break % | 127.1 | 99.1 |
| 25′ 175° C. | | |
| Tear strength MPa | 0.61 | 0.31 |
| 25′ 175° C. | | |

The results show, in a particularly impressive manner, that the tear strength and in particular also the elongation at break are affected positively by the higher proportion of liquid cis-1,4-polyisoprene in example 4, without the viscosity increasing into the range which would no longer permit plastisol-like application.

### Examples 6 -8

In the following are given application examples of compositions according to the invention for lap-joint sealing (ex. 6), an underseal adhesive (ex. 7) and a lap-joint adhesive (ex. 8).

| Ex. 6 | Ex. 7 | Ex. 8 | |
|---|---|---|---|
| 7.00 | 7.00 | 10.00 | cis-1,4-polyisoprene, liquid, MW 29000 |
| 8.00 | 8.00 | 15.00 | zinc oxide |
| 8.00 | 8.00 | 15.00 | calcium oxide |
| 0.50 | 0.50 | 0.50 | 2,2-methylene-bis-(4-methyl-6- |
| | | | t-butylphenol) |
| 0.50 | 0.50 | 0.40 | ca. 65% p-benzoquinone dioxime, |
| | | | desensitized with ca. 35% mineral oil |
| | | | raffinate |
| 19.30 | 17.1 | — | Mg-Al silicate |
| 9.40 | 9.40 | 12.00 | calcium carbonate, coated with stearate |
| 12.80 | 13.00 | 7.00 | polybutadiene, liquid, MW ca. 1800, |
| | | | cis-1,4 ca. 72% |
| 2.70 | 2.70 | 2.50 | polybutadiene with active carboxyl |
| | | | groups, MW ca. 1700 |
| 10.25 | 9.50 | 5.00 | low mol. wt. stereospec. PB oil, |
| | | | MW 1800, vinyl 50% |
| 1.75 | 5.50 | 4.75 | sulfur |
| 4.50 | 4.50 | 5.00 | MBTS |
| 0.50 | 0.50 | — | MBT |
| 0.50 | 0.50 | — | ZMBT |
| 9.00 | 9.00 | 12.00 | technical grade white oil, paraffin |
| | | | raffinate |
| 0.30 | 0.30 | — | zinc dimethyldithiocarbamate |
| 3.00 | — | — | titanium dioxide |
| 1.50 | — | — | hydrogenated castor oil |
| — | 1.00 | 0.60 | silicon dioxide |
| — | 3.00 | 0.50 | carbon black |
| — | — | 9.25 | calcium carbonate |
| — | — | 0.50 | hexamethylene bisthiosulfate |

Experimental Data:

| | Ex. 6 | Ex. 7 | Ex. 8 |
|---|---|---|---|
| TSS [MPa]: | 0.60 | 2.18 | 4.75 |
| 25′ 175° C. | | | |

The tensile shear strengths of examples 6 to 8 show that these can be adjusted to the corresponding specifications for lap-joint sealing, where a low tensile shear strength (TSS) is required, and also for an underseal adhesive and a lap-joint adhesive where high strength is required.

1. A hot-curing reactive composition based on natural and/or synthetic elastomers which contain olefinic double bonds and vulcanization agents, characterised in that they contain
a) at least one liquid cis-1,4-polyisoprene with a molecular weight between 20000 and 70000, preferably between 20000 and 50000,
b) a vulcanization system consisting of sulfur, accelerators and quinonoximes.

2. Composition according to claim 1, characterised in it also contains at least one further liquid polyene from the group consisting of 1,2-polybutadiene, 1,4-polybutadiene, polyisoprene, polybutene, polyisobutylene, copolymers of butadiene and/or isoprene with styrene and/or acrylonitrile, copolymers of acrylates with dienes, wherein the molecular weight of the liquid polyene is in the range 900 to about 40000.

3. Composition according to claim 2, characterised in that the liquid polyene(s) also contain terminal and/or randomly distributed carboxyl groups, carboxylic anhydride groups, hydroxyl groups, amino groups, mercapto groups or epoxy groups as functional groups.

4. Composition according to at least one of the preceding claims, characterised in that it does not contain any solid rubbers.

5. Composition according to at least one of the preceding claims, characterised in it also contains fillers, rheology auxiliary substances, extender oils, bonding agents and/or anti-aging agents.

6. Composition according to at least one of the preceding claims, characterised in that it has plastisol-like flow characteristics.

7. Preparation of the hot-curing reactive composition according to at least one of the preceding claims by mixing the components under high shear.

8. Use of the composition according to at least one of the preceding claims as a single- or two-component adhesive, sealant or coating composition in car shells.

9. Process for sealing coarse and/or fine joints in vehicle shells, characterised in that it comprises the following essential process steps
a) applying the composition according to claims 1 to 6 to at least one shell part by spraying or extruding,
b) joining the shell parts, optionally followed by (spot)-welding, lap-jointing, screwing and/or riveting,
c) optionally partly curing the composition by briefly heating the parts to temperatures of up to 190° C.,
d) optionally cleaning/washing the joined shell parts, optionally followed by conventional surface pretreatments,
e) electrodeposition lacquering,
f) curing and/or cross-linking the sealing composition while firing on the electrodeposition lacquer at temperatures between 160° C. and 240° C.
10. Process for undersealing structural parts in vehicle shells, characterised in that it comprises the following essential process steps
a) applying the composition according to claims 1 to 6 to at least one shell part by spraying or extruding,.
b) joining the shell parts, optionally followed by (spot)-welding, lap-jointing, screwing and/or riveting,
c) optionally partly curing the composition by briefly heating the parts to temperatures of up to 190° C.,
d) optionally cleaning/washing the joined shell parts, optionally followed by conventional surface pretreatments,
e) electrodeposition lacquering,
f) curing and/or cross-linking the underseal adhesive while firing on the electrodeposition lacquer at temperatures between 160° C. and 240° C.
